(19) United States
(12) Patent Application Publication
(10) Pub. No.: US 2021/0274358 A1
(43) Pub. Date: Sep. 2, 2021

(54) METHOD, APPARATUS AND COMPUTER PROGRAM FOR PERFORMING THREE DIMENSIONAL RADIO MODEL CONSTRUCTION

(71) Applicant: NOKIA TECHNOLOGIES OY, Espoo (FI)

(72) Inventors: Akash SHANKAR, Stuttgart (DE); Qi LIAO, Stuttgart (DE)

(21) Appl. No.: 17/257,992

(22) PCT Filed: Jul. 6, 2018
(86) PCT No.: PCT/EP2018/068361

§ 371 Date: Jan. 5, 2021

(51) Int. Cl. H04W 16/20; H04W 24/02; G01S 13/89; H04W 64/00; H04W 88/08

(52) U.S. Cl. CPC H04W 16/20; H04W 24/02; H04W 88/08; H04W 64/003; G01S 13/89

(57) ABSTRACT

An apparatus comprising means for performing: sending a request to a user device, wherein the user device is located in an environment; receiving, in response to the request, image information of the environment from the user device; constructing a three dimensional model of the environment based on the image information; obtaining information from the three dimensional model of the environment; and generating a radio propagation model of the environment using information obtained from the three dimensional model of the environment.

### TECHNICAL FIELD

Various examples relate to a method, apparatus and a computer program. More particularly, various examples relate to radio model construction, and more particularly to a method and apparatus for performing three dimensional radio model construction.

### BACKGROUND

A user device may be positioned in an environment comprising a radio network. For network planning and for network optimization, it may be required to have information of how radio waves propagate in the environment.

Two dimensional radio coverage maps can be used to provide a two dimensional representation of radio coverage in an environment.

### SUMMARY

According to a first aspect, there is provided an apparatus comprising means for performing: sending a request to a user device, wherein the user device is located in an environment; receiving, in response to the request, image information of the environment from the user device; constructing a three dimensional model of the environment based on the image information; obtaining information from the three dimensional model of the environment; and generating a radio propagation model of the environment using information obtained from the three dimensional model of the environment.

In an example, the constructing a three dimensional model of the environment comprises using a localization and mapping technique and an object recognition technique.

In an example, the constructing a three dimensional model comprises detecting an object in the environment using the object recognition technique and constructing a position and shape of the object in the three dimensional model of the environment.

In an example, the constructing a three dimensional model comprises determining a material and/or type of the object using the object recognition technique.

In an example, the obtaining information comprises obtaining at least one of: information of a user device's position within the three dimensional environment; information of a position and shape of at least one object in the three dimensional environment; information of a surface material of at least one object in the environment.

In an example, the constructing a three dimensional model comprises determining a position of an access point located in the environment using the object recognition technique.

In an example, the constructing a three dimensional model comprises recognising a type of the access point located in the environment.

In an example, the means are further configured to perform: generating a virtual radio coverage map and/or at least one performance metric based on: the radio propagation model; the determined position of the access point located in the environment and the recognised type of the access point.

In an example, the means are further configured to perform: receiving, from the user device, information regarding a preferred type of access point of the user device and/or receiving information regarding a preferred access point deployment location of the user device.

In an example, the means are further configured to perform: generating a virtual radio coverage map and/or at least one performance metric based on: the radio propagation model; a position of the access point in the environment and the preferred type of access point.

In an example, the means are further configured to perform: sending the virtual radio coverage map and/or at least one performance metric to the user device.

In an example, the at least one performance metric comprises network capacity and network latency.

In an example, the means are further configured to perform: receiving context information of the environment from the user device; and using the context information to construct the three dimensional model of the environment.

In an example, the context information is provided by haptic and/or speech feedback by a user at the user device.

In an example, the context information is recorded by sensors of the user device.

In an example, the means are further configured to perform: network planning or network optimization.

In an example, the means are further configured to perform: providing a suggested optimized access point deployment location to the user device.

In an example, multiple optimized access point deployment locations are provided to the user device.

In an example, the means are further configured to provide to the user device: a suggestion to deploy multiple access points in the environment.

In an example, the means are further configured to perform:

receiving movement information of the user device and/or radio signal measurements from the user device.

In an example, the localization and mapping technique comprises a simultaneous localization and mapping algorithm.

In an example, the object recognition technique uses convolutional neural networks.

According to a second aspect there is provided an apparatus comprising means for: receiving, from a server, a request for image information for constructing a three dimensional model of an environment in which the apparatus is located; and sending, in response to the request, image information of an environment to the server.

In an example, the means are further configured to perform: sending information regarding a preferred type of access point of the apparatus to the server and/or sending information regarding a preferred access point deployment location of the user device.

In an example, the means are further configured to perform:

sending movement information and/or radio signal measurements to the server.

In an example, the means are further configured to perform: receiving a virtual radio coverage map and/or at least one performance metric, wherein the virtual radio coverage map and/or at least one performance metric is based on: a radio propagation model; a position of the access point and at least one of: the preferred type of the access point; and a type of the access point in the environment detected by the server.

In an example, the means are further configured to perform: receiving a suggested optimized access point deployment location and displaying the suggested optimized access point deployment location to a user.

In an example, the means are further configured to perform: receiving the virtual radio coverage map and/or at least one performance metric from the server.

In an example, the at least one performance metric comprises network capacity and network latency.

In an example, the means are further configured to perform: sending context information of the environment to the server. In an example, the context information is provided by haptic and/or speech feedback by a user at the apparatus.

In an example, the context information is recorded by sensors of the apparatus.

In an example, the means are further configured to perform: receiving, from the server, multiple optimized access point deployment locations.

In an example, the means are further configured to perform: receiving a suggestion from the server to deploy multiple access points in the environment.

According to a third aspect, there is provided an apparatus comprising: at least one processor; at least one memory including computer program code; wherein the at least one memory and computer program code is configured to, with the at least one processor, cause the apparatus at least to perform: sending a request to a user device, wherein the user device is located in an environment; receiving, in response to the request, image information of the environment from the user device; constructing a three dimensional model of the environment based on the image information; obtaining information from the three dimensional model of the environment; and generating a radio propagation model of the environment using information obtained from the three dimensional model of the environment.

In an example, the constructing a three dimensional model of the environment comprises using a localization and mapping technique and an object recognition technique.

In an example, the constructing a three dimensional model comprises detecting an object in the environment using the object recognition technique and constructing a position and shape of the object in the three dimensional model of the environment.

In an example, the constructing a three dimensional model comprises determining a material and/or type of the object using the object recognition technique.

In an example, the obtaining information comprises obtaining at least one of: information of a user device's position within the three dimensional environment; information of a position and shape of at least one object in the three dimensional environment; information of a surface material of at least one object in the environment.

In an example, the constructing a three dimensional model comprises determining a position of an access point located in the environment using the object recognition technique.

In an example, the constructing a three dimensional model comprises recognising a type of the access point located in the environment.

In an example, the apparatus is caused to generate a virtual radio coverage map and/or at least one performance metric based on: the radio propagation model; the determined position of the access point located in the environment and the recognised type of the access point.

In an example, the at least one memory and computer program code is configured to, with the at least one processor, cause the apparatus to perform receiving, from the user device, information regarding a preferred type of access point of the user device and/or receiving information regarding a preferred access point deployment location of the user device.

In an example, the at least one memory and computer program code is configured to, with the at least one processor, cause the apparatus to perform generating a virtual radio coverage map and/or at least one performance metric based on: the radio propagation model; a position of the access point in the environment and the preferred type of access point.

In an example, the at least one memory and computer program code is configured to, with the at least one processor, cause the apparatus to perform sending the virtual radio coverage map and/or at least one performance metric to the user device.

In an example, the at least one performance metric comprises network capacity and network latency.

In an example, the at least one memory and computer program code is configured to, with the at least one processor, cause the apparatus to perform: receiving context information of the environment from the user device; and using the context information to construct the three dimensional model of the environment.

In an example, the context information is provided by haptic and/or speech feedback by a user at the user device.

In an example, the context information is recorded by sensors of the user device.

In an example, the apparatus is caused to perform network planning or network optimization.

In an example, the at least one memory and computer program code is configured to, with the at least one processor, cause the apparatus to perform providing a suggested optimized access point deployment location to the user device.

In an example, multiple optimized access point deployment locations are provided to the user device.

In an example, the at least one memory and computer program code is configured to, with the at least one processor, cause the apparatus to perform providing to the user device: a suggestion to deploy multiple access points in the environment.

In an example, the at least one memory and computer program code is configured to, with the at least one processor, cause the apparatus to perform receiving movement information of the user device and/or radio signal measurements from the user device.

In an example, the localization and mapping technique comprises a simultaneous localization and mapping algorithm.

In an example, the object recognition technique uses convolutional neural networks.

According to a fourth aspect there is provided an apparatus comprising: at least one processor; at least one memory including computer program code; wherein the at least one memory and computer program code is configured to, with the at least one processor, cause the apparatus at least to perform: receiving, from a server, a request for image information for constructing a three dimensional model of an environment in which the apparatus is located; and sending, in response to the request, image information of an environment to the server.

In an example, the at least one memory and computer program code is configured to, with the at least one processor, cause the apparatus to perform sending information regarding a preferred type of access point of the apparatus to the server; and/or send information regarding a preferred access point deployment location of the user device.

In an example, the at least one memory and computer program code is configured to, with the at least one processor, cause the apparatus to perform sending movement information and/or radio signal measurements to the server.

In an example, the at least one memory and computer program code is configured to, with the at least one processor, cause the apparatus to perform receiving a virtual radio coverage map and/or at least one performance metric, wherein the virtual radio coverage map and/or at least one performance metric is based on: a radio propagation model; a position of the access point and at least one of: the preferred type of the access point; and a type of the access point in the environment detected by the server.

In an example, the at least one memory and computer program code is configured to, with the at least one processor, cause the apparatus to perform receiving a suggested optimized access point deployment location and for displaying the suggested optimized access point deployment location to a user.

In an example, the at least one memory and computer program code is configured to, with the at least one processor, cause the apparatus to perform receiving the virtual radio coverage map and/or at least one performance metric from the server.

In an example, the at least one performance metric comprises network capacity and network latency.

In an example, the at least one memory and computer program code is configured to, with the at least one processor, cause the apparatus to perform sending context information of the environment to the server.

In an example, the context information is provided by haptic and/or speech feedback by a user at the apparatus.

In an example, the context information is recorded by sensors of the apparatus.

In an example, the at least one memory and computer program code is configured to, with the at least one processor, cause the apparatus to perform receiving, from the server, multiple optimized access point deployment locations.

In an example, the at least one memory and computer program code is configured to, with the at least one processor, cause the apparatus to perform receiving a suggestion from the server to deploy multiple access points in the environment.

According to a fifth aspect there is provided a method comprising: sending a request to a user device, wherein the user device is located in an environment; receiving, in response to the request, image information of the environment from the user device; constructing a three dimensional model of the environment based on the image information; obtaining information from the three dimensional model of the environment; and generating a radio propagation model of the environment using information obtained from the three dimensional model of the environment.

In an example, the constructing a three dimensional model of the environment comprises using a localization and mapping technique and an object recognition technique.

In an example, the constructing a three dimensional model comprises detecting an object in the environment using the object recognition technique and constructing a position and shape of the object in the three dimensional model of the environment.

In an example, the constructing a three dimensional model comprises determining a material and/or type of the object using the object recognition technique.

In an example, the obtaining information comprises obtaining at least one of: information of a user device's position within the three dimensional environment; information of a position and shape of at least one object in the three dimensional environment; information of a surface material of at least one object in the environment.

In an example, the constructing a three dimensional model comprises determining a position of an access point located in the environment using the object recognition technique.

In an example, the constructing a three dimensional model comprises recognising a type of the access point located in the environment.

In an example, the method further comprises: generating a virtual radio coverage map and/or at least one performance metric based on: the radio propagation model; the determined position of the access point located in the environment and the recognised type of the access point.

In an example, the method further comprises: receiving, from the user device, information regarding a preferred type of access point of the user device and/or receiving information regarding a preferred access point deployment location of the user device.

In an example, the method further comprises: generating a virtual radio coverage map and/or at least one performance metric based on: the radio propagation model; a position of the access point in the environment and the preferred type of access point.

In an example, the method further comprises: sending the virtual radio coverage map and/or at least one performance metric to the user device.

In an example, the at least one performance metric comprises network capacity and network latency.

In an example, the method further comprises: receiving context information of the environment from the user device; and using the context information to construct the three dimensional model of the environment.

In an example, the context information is provided by haptic and/or speech feedback by a user at the user device.

In an example, context information is recorded by sensors of the user device.

In an example, the method further comprises: performing network planning or network optimization.

In an example, the method further comprises: providing a suggested optimized access point deployment location to the user device.

In an example, multiple optimized access point deployment locations are provided to the user device.

In an example, the method further comprises providing, to the user device, a suggestion to deploy multiple access points in the environment.

In an example the method further comprises: receiving movement information of the user device and/or radio signal measurements from the user device.

In an example, the localization and mapping technique comprises a simultaneous localization and mapping algorithm.

In an example, the object recognition technique uses convolutional neural networks.

According to a sixth aspect there is provided a method comprising: receiving, from a server, a request for image information for constructing a three dimensional model of an environment in which the apparatus is located; and sending, in response to the request, image information of an environment to the server.

In an example, the method may further comprise: sending information regarding a preferred type of access point of the apparatus to the server and/or sending information regarding a preferred access point deployment location of the user device.

In an example, the method may further comprise: sending movement information and/or radio signal measurements to the server.

In an example, the method may further comprise: receiving a virtual radio coverage map and/or at least one performance metric, wherein the virtual radio coverage map and/or at least one performance metric is based on: a radio propagation model; a position of the access point and at least one of: the preferred type of the access point; and a type of the access point in the environment detected by the server.

In an example, the method may further comprise: receiving a suggested optimized access point deployment location and for displaying the suggested optimized access point deployment location to a user.

In an example, the method may further comprise: receiving the virtual radio coverage map and/or at least one performance metric from the server.

In an example, the at least one performance metric comprises network capacity and network latency.

In an example, the method may further comprise: sending context information of the environment to the server.

In an example, the context information is provided by haptic and/or speech feedback by a user at the apparatus.

In an example, the context information is recorded by sensors of the apparatus.

In an example, the method may further comprise: receiving, from the server, multiple optimized access point deployment locations.

In an example, the method may further comprise: receiving a suggestion from the server to deploy multiple access points in the environment.

According to a seventh aspect, there is provided a computer program comprising instructions for causing an apparatus to perform at least the following: sending a request to a user device, wherein the user device is located in an environment; receiving, in response to the request, image information of the environment from the user device; constructing a three dimensional model of the environment based on the image information; obtaining information from the three dimensional model of the environment; and generating a radio propagation model of the environment using information obtained from the three dimensional model of the environment.

According to an eighth aspect, there is provided a non-transitory computer readable medium comprising program instructions for causing an apparatus to perform at least following: sending a request to a user device, wherein the user device is located in an environment; receiving, in response to the request, image information of the environment from the user device; constructing a three dimensional model of the environment based on the image information; obtaining information from the three dimensional model of the environment; and generating a radio propagation model of the environment using information obtained from the three dimensional model of the environment.

In an example, the constructing a three dimensional model of the environment comprises using a localization and mapping technique and an object recognition technique.

In an example, the constructing a three dimensional model comprises detecting an object in the environment using the object recognition technique and constructing a position and shape of the object in the three dimensional model of the environment.

In an example, the constructing a three dimensional model comprises determining a material and/or type of the object using the object recognition technique.

In an example, the obtaining information comprises obtaining at least one of: information of a user device's position within the three dimensional environment; information of a position and shape of at least one object in the three dimensional environment; information of a surface material of at least one object in the environment.

In an example, the constructing a three dimensional model comprises determining a position of an access point located in the environment using the object recognition technique.

In an example, the constructing a three dimensional model comprises recognising a type of the access point located in the environment.

In an example, the apparatus is caused to perform: generating a virtual radio coverage map and/or at least one performance metric based on: the radio propagation model; the determined position of the access point located in the environment and the recognised type of the access point.

In an example, the apparatus is caused to perform: receiving, from the user device, information regarding a preferred type of access point of the user device and/or receiving information regarding a preferred access point deployment location of the user device.

In an example, the apparatus is caused to perform: generating a virtual radio coverage map and/or at least one performance metric based on: the radio propagation model; a position of the access point in the environment and the preferred type of access point.

In an example, the apparatus is caused to perform: sending the virtual radio coverage map and/or at least one performance metric to the user device.

In an example, the at least one performance metric comprises network capacity and network latency.

In an example, the apparatus is caused to perform: receiving context information of the environment from the user device; and using the context information to construct the three dimensional model of the environment.

In an example, the context information is provided by haptic and/or speech feedback by a user at the user device.

In an example, context information is recorded by sensors of the user device.

In an example, the apparatus is caused to perform: performing network planning or network optimization.

In an example, the apparatus is caused to perform: providing a suggested optimized access point deployment location to the user device.

In an example, multiple optimized access point deployment locations are provided to the user device.

In an example, the apparatus is caused to perform: providing, to the user device, a suggestion to deploy multiple access points in the environment.

In an example, the apparatus is caused to perform receiving movement information of the user device and/or radio signal measurements from the user device.

In an example, the localization and mapping technique comprises a simultaneous localization and mapping algorithm. In an example, the object recognition technique uses convolutional neural networks.

According to an ninth aspect there is provided a computer program comprising instructions for causing an apparatus to perform at least the following: receiving, from a server, a request for image information for constructing a three dimensional model of an environment in which the apparatus is located; and sending, in response to the request, image information of an environment to the server.

According to a tenth aspect, there is provided a non-transitory computer readable medium comprising program instructions for causing an apparatus to perform at least following: receiving, from a server, a request for image information for constructing a three dimensional model of an environment in which the apparatus is located; and sending, in response to the request, image information of an environment to the server.

In an example, the apparatus is caused to perform: sending information regarding a preferred type of access point of the apparatus to the server and/or sending information regarding a preferred access point deployment location of the user device.

In an example, the apparatus is caused to perform: sending movement information and/or radio signal measurements to the server.

In an example, the apparatus is caused to perform: receiving a virtual radio coverage map and/or at least one performance metric, wherein the virtual radio coverage map and/or at least one performance metric is based on: a radio propagation model; a position of the access point and at least one of: the preferred type of the access point; and a type of the access point in the environment detected by the server.

In an example, the apparatus is caused to perform: receiving a suggested optimized access point deployment location and for displaying the suggested optimized access point deployment location to a user.

In an example, the apparatus is caused to perform: receiving the virtual radio coverage map and/or at least one performance metric from the server.

In an example, the at least one performance metric comprises network capacity and network latency.

In an example, the apparatus is caused to perform: sending context information of the environment to the server.

In an example, the context information is provided by haptic and/or speech feedback by a user at the apparatus.

In an example, the context information is recorded by sensors of the apparatus.

In an example, the apparatus is caused to perform: receiving, from the server, multiple optimized access point deployment locations.

In an example, the apparatus is caused to perform: receiving a suggestion from the server to deploy multiple access points in the environment.

In an eleventh aspect there is provided a computer program comprising instructions stored thereon for performing at least the following: sending a request to a user device, wherein the user device is located in an environment; receiving, in response to the request, image information of the environment from the user device; constructing a three dimensional model of the environment based on the image information; obtaining information from the three dimensional model of the environment; and generating a radio propagation model of the environment using information obtained from the three dimensional model of the environment.

In a twelfth aspect there is provided a non-transitory computer readable medium comprising program instructions thereon for performing at least the following: sending a request to a user device, wherein the user device is located in an environment; receiving, in response to the request, image information of the environment from the user device; constructing a three dimensional model of the environment based on the image information; obtaining information from the three dimensional model of the environment; and generating a radio propagation model of the environment using information obtained from the three dimensional model of the environment.

In a thirteenth aspect there is provided a computer program comprising instructions stored thereon for performing at least the following: receiving, from a server, a request for image information for constructing a three dimensional model of an environment in which the apparatus is located; and sending, in response to the request, image information of an environment to the server.

In a fourteenth aspect there is provided a non-transitory computer readable medium comprising program instructions thereon for performing at least the following: receiving, from a server, a request for image information for constructing a three dimensional model of an environment in which the apparatus is located; and sending, in response to the request, image information of an environment to the server.

In the above, various aspects have been described. It should be appreciated that further aspects may be provided by the combination of any two or more of the aspects described above.

Various other aspects and further embodiments are also described in the following detailed description and in the attached claims.

### BRIEF DESCRIPTION OF THE DRAWINGS

To assist understanding of the present disclosure and to show how some embodiments may be put into effect, reference is made by way of example only to the accompanying drawings in which:

FIG. 1 shows schematically an example of an environment;

FIG. 2 shows schematically an example of a system;

FIG. 3 shows schematically an example of an environment;

FIG. 4 shows schematically a method for constructing a three dimensional radio model according to an example;

FIG. 5 shows schematically a method for using a radio propagation model according to an example;

FIG. 6 shows a first method flow according to an example; and

FIG. 7 shows a second method flow according to an example.

### DETAILED DESCRIPTION

Some examples may be provided in the context of network planning or network optimization.

Radio map construction may be used for network planning and optimization. The growing markets of the fifth generation (5G) wireless access and unmanned aerial vehicle (UAV) services have pushed up the demand for radio maps provided in three dimensional (3D) space. Such demand gives rise to new technical challenges such as how to quickly and efficiently estimate position-dependent network performance in 3D space. Network performance can be signified, for example, by signal strength and/or network throughput (data rate). A further challenge is how to simplify the collection of data that is required in order to construct a radio map or perform network planning and network optimization. For example, in large-scale environments (e.g. a manufacturing plant) the process of collecting site survey data for constructing a virtual radio map can take a long time and can be labour intensive.

In certain examples, a network planning and optimization service which uses visual-based 3D network environment construction is described. In some examples, the network planning and optimization service may provide information based on a radio propagation model (a “digital twin”) of an environment.

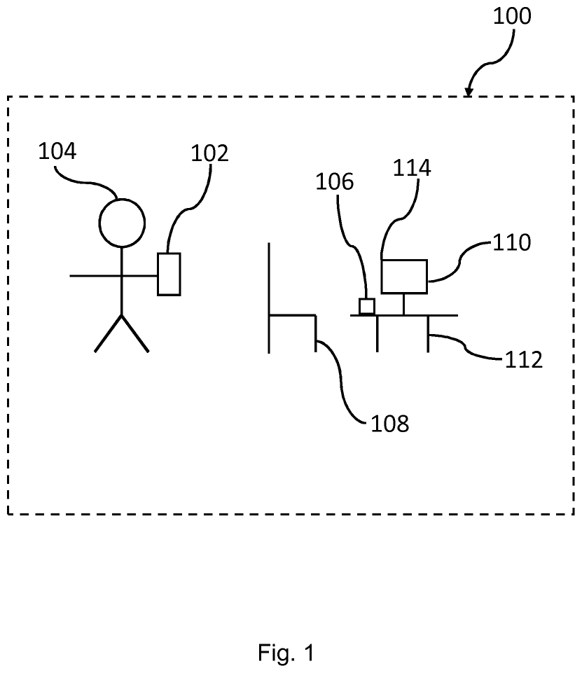

The method and apparatus may be used to provide information regarding an environment 100, such as that schematically shown in FIG. 1. Although FIG. 1 is schematically presented in 2D, it will be understood that the environment 100 comprises a 3D environment. In the 3D environment 100, there may be located a user device 102, a user 104, an access point (AP) 106, and objects such as chair 108, screen 110 (e.g. screen of a computer) and table 112. The environment 100 may be an indoor environment such as a home or office. The environment 100 may alternatively comprise an outdoor environment. The environment 100 may also comprise both indoor and outdoor environments.

In the environment 100 there may also be certain features, which may be considered “keypoints” or “interest points” that stand out in a two dimensional (2D) image of the environment. A feature could for example be a corner or an edge of an item in the environment. An exemplary feature, which is the corner of screen 110 is shown at 114 in FIG. 1. The environment may comprise further features e.g. further keypoints.

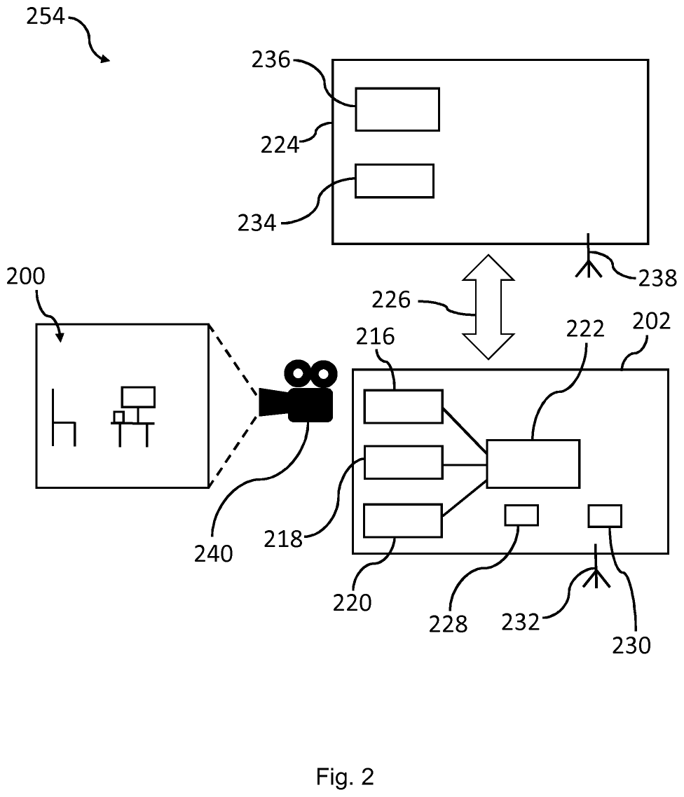

An exemplary system of some examples will now be described in more detail with reference to FIG. 2, which shows a schematic representation of a system 254. The exemplary system 254 comprises a user device 202 and a server device 224.

The user device 202 may comprise at least at least one data processing entity 228, at least one memory 230, and other possible components for use in software and hardware aided execution of tasks it is designed to perform, including control of access to and communications with server devices and other communication devices. The at least one memory 228 may be in communication with the data processing entity 230, which may be a data processor. The data processing, storage and other relevant control apparatus can be provided on an appropriate circuit board and/or in chipsets.

The user device 202 may optionally comprise a user interface such as key pad, voice commands, touch sensitive screen or pad, combinations thereof or the like. One or more of a display 220, a speaker and a microphone may optionally be provided. Furthermore, a user device 202 may comprise appropriate connectors (either wired or wireless) to other devices and/or for connecting external accessories, for example hands-free equipment, thereto. The display 220 may be a haptic display capable of providing a user with haptic feedback, for example in response to user input.

The user device 202 may receive signals over an air or radio interface 226 via appropriate apparatus for receiving, and may transmit signals via appropriate apparatus for transmitting radio signals. In FIG. 2 a transceiver apparatus is shown schematically at 232. The transceiver apparatus 232 may be provided for example by means of a radio part and associated antenna arrangement. The antenna arrangement may be arranged internally or externally to the wireless device. The transceiver apparatus 232 may be controlled by communication unit 222.

In examples, the user device 202 may comprise a data collection module 218. The data collection module 218 may comprise a movement measurement apparatus. The movement measurement apparatus may comprise an inertial measurement unit capable of measuring movement, rotation and velocity of the user device 202. The inertial measurement unit may comprise, for example, an accelerometer and/or a gyroscope.

The data collection module 218 may comprise a radio signal measurement unit for collecting information such as signal strength and/or data rate at locations in an environment 200. In some examples the radio signal measurement unit may be provided in addition to the movement measurement apparatus. In some examples the radio signal measurement unit is provided, and the movement measurement apparatus is not provided.

The user device 202 may comprise an image information recording unit 216 for recording image information. The image information may comprise, for example, 2D image frames. In some examples the 2D image frames comprise still image frames. In some examples the 2D image frames comprise motion picture image frames. The image information unit 216 may comprise a camera module. The camera module may be embedded in the user device 202, or it may be provided as a standalone equipment which can connect to a network via a wireless or wired communication unit.

The server 224 may receive signals over an air or radio interface, such as interface 226 via appropriate apparatus for receiving, and may transmit signals via appropriate apparatus for transmitting radio signals. In FIG. 2 a transceiver apparatus of server device 224 is shown schematically at 238. The transceiver apparatus 238 may be provided for example by means of a radio part and associated antenna arrangement. The antenna arrangement may be arranged internally or externally to the wireless device. The transceiver apparatus 238 may be controlled by a communication unit.

As schematically shown at 240, the image information recording unit 216 may provide image information relating to an environment 200. The user device and camera may be located in the environment 200.

The user device 202 may be in contact with a server device 224 over interface 226. The server device 224 may comprise at least at least one data processing entity 234, at least one memory 236, and other possible components for use in software and hardware aided execution of tasks it is designed to perform, including control of access to and communications with user devices and other communication devices. The at least one memory 236 may be in communication with the data processing entity 234, which may be a data processor. The data processing, storage and other relevant control apparatus can be provided on an appropriate circuit board and/or in chipsets.

The server device may be located in the “cloud”. The method steps provided by the server 224 may be provided by a service cloud. The server device may perform data analysis and network planning and optimization.

In order to provide a radio propagation model of a 3D environment in which network planning and optimization tasks can be carried out, it is proposed to use a visual based method to construct a 3D model of the environment. Information from the constructed 3D model of the environment can then be extracted (or obtained) in order to create (or generate) the radio propagation model. By using a visual based method to construct a 3D model of a 3D environment and generating a radio propagation model from the 3D model, it is then not necessary to carry out site survey data measurements (for example signal strength measurements) in order to generate the radio propagation model. Furthermore, it is not necessary for a user to provide a blueprint or map of the 3D environment, as the 3D environment is constructed as a 3D model using image information (such as image frames from a camera). In other words, in some examples no actual radio measurements are taken in order to generate the 3D model. Rather, radio information (e.g. signal strength) at a position in the model (and hence the environment) may be calculated or determined on the basis of the received image information and without need for actual or physical radio measurements being obtained.

In order to construct the 3D model of the environment, the user device 202 may send image information, which may be collected from image information recording unit 216, to server 224. Further information may be sent, for example at least one of: radio signal measurement information, movement information and specified network requirements (e.g. preferred/installed models of an AP and/or quality of service requirements). The service cloud may analyze the data and construct or update a model of the 3D environment as described further below. Simultaneously, the user device's location and viewpoint may optionally be kept track of, for example by using computer vision techniques as described further below.

In order to construct the 3D model of the environment, localization and mapping techniques (for example the simultaneous localization and mapping (SLAM) algorithm) and deep learning-based object recognition techniques (for example, convolutional neural networks (ConvNets)) are used.

As mentioned above, an exemplary localization and mapping technique is the SLAM algorithm. SLAM can be used to construct or update a map of an unknown environment while simultaneously keeping track of a device's location within it. A SLAM algorithm may be termed a “visual SLAM algorithm” when the solution(s) is/are based on visual information alone. The outputs of a visual SLAM algorithm may comprise a 3D point cloud of the environment around the user device as well as the device's own position and viewpoint with respect to the environment. SLAM algorithms can be used to detect a user device's trajectory.

As mentioned above, ConvNets can be used as a deep learning-based object recognition technique. Although SLAM can capture the toplogical relationship between user device and the environment, ConvNets can be used to provide additional information about obstacles in an environment that a radio wave will encounter within the environment, which may be useful for providing a radio propagation model. This may be useful for high frequency radio spectrums with narrow-beam characteristics such as millimetre wave (mmWave) frequency radio spectrums.

For example, SLAM may be able to determine an obstacle, but may not be able to determine some of the physical properties of the obstacle. An example of this is that SLAM may not be able to differentiate whether an obstacle is wooden or metallic. A metallic obstacle will attenuate a signal to a higher degree when compared to a wooden obstacle. ConvNets can be used to identify from an image the properties of an object such as its material. ConvNets can also be used to determine a type of an object e.g. a person, a car, a chair, etc. ConvNets can be used to detect, segment and recognise objects and regions in images. ConvNets can therefore be used to recognise objects in a 3D environment based on image information of the environment. ConvNets can also be used to recognise APs when they are deployed in an environment. ConvNets may be used to provide information regarding a position of the AP in the environment. ConvNets may provide information regarding a type of AP e.g. a person, a car, a chair, etc.

In some examples, by combining localization and mapping techniques and object recognition techniques it is therefore possible to generate a 3D model of the environment, from which at least some of the following information can be obtained to generate a radio propagation model:
A user device's trajectory within the 3D environment;
A user device's viewpoint within the 3D environment;
A position of one or more obstacles in the 3D environment;
A shape of the one or more obstacles in the 3D environment;
A surface material of the one or more obstacles in the 3D environment;
A type of the one or more obstacles in the 3D environment;
A position of one or more deployed APs in the 3D environment;
A type or types of one or more APs deployed in the 3D environment.

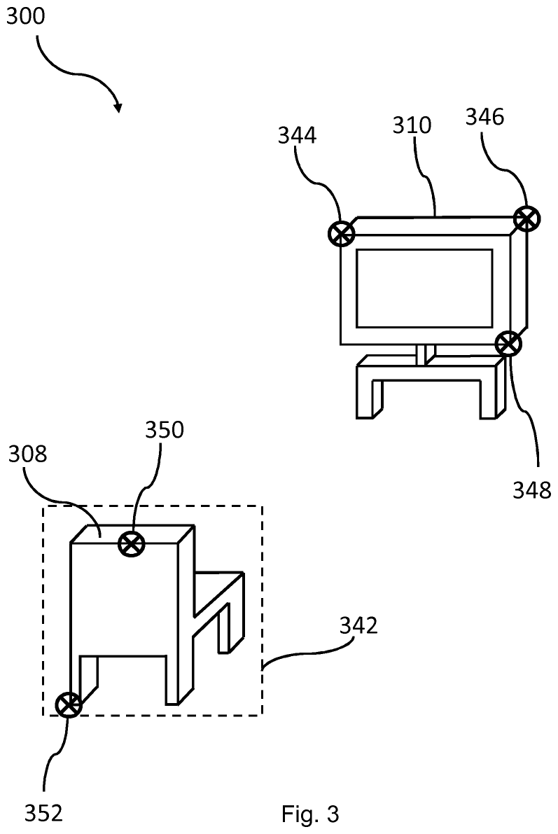

In order to discuss certain examples, certain terms and phrases are discussed below with reference to FIG. 3.

A feature (keypoint), such as feature 114 shown schematically in FIG. 1, may comprise a selected image region with an associated descriptor. Features may be considered the interest points that stand out or are prominent in the 2D image. If an image is modified, for example the image is rotated, its scale is changed or it is distorted, it should be possible to find the same features in the original image and the modified image. These 2D points can help to identify and track a “marker” (e.g., a map points or a key target) in a 3D space. To identify these features (keypoints), the features may be associated with descriptors that describe the characteristics of the extracted features. Exemplary features 352, 350, 344, 346 and 348 of objects 308 and 310 (a chair and a screen, respectively) located in environment 300 are shown in FIG. 3.

There are various feature detectors available. These include Scale-Invariant Feature Transform (SIFT), the Speeded Up Robust Features (SURF), the Harris corner detector (HARRIS), Features from Accelerated Segment Test (FAST) and ORB (Orientated FAST and Rotated BRIEF (Binary Robust Independent Elementary Features)).

In examples, HARRIS can be used with subpixel accuracy.

In a further non-limiting example, the ORB detector and descriptor, which can detect corners, may be used. ORB was developed based on oriented FAST feature detector and rotated BRIEF descriptor. In ORB, for each detected feature Fᵢ the following information is stored:
the 2D location of its centroid uᵢ^{(im)}∈ [symbol] ² in the image coordinate system;
its diameter of the meaningful feature neighbourhood rᵢ∈ [symbol] ²;
its angle of orientation oᵢ∈[0, 360];
its descriptor as a finite vector τᵢ∈ [symbol] ^{L} that summarizes the properties for the feature. For example, BRIEF descriptor describes the binary intensity comparisons between a set of L location pairs of a local image patch of feature Fᵢ;
target class id Iᵢ that can be used to cluster features by a target object they belong to.

Map points may form the structure of a 3D reconstruction of the world. Map points can be used to construct a 3D model of an environment. Each map point Mⱼ may correspond to a textured planar patch in the world. A position of the map point can be triangulated from different views. The position of each map point may also be refined by bundle adjustment. Map points may be considered markers in a reconstructed 3D space. Map points may be associated with one or more keypoints (features) detected in different features. A single map point may associate with features in several keyframes (keyframes are discussed below), and therefore several descriptors may be associated with a map point. The following information may be stored for each map point:
its 3D location vⱼ^{(w)}∈ [symbol] ³ in the world coordinate system;
a viewing direction d̅ⱼ∈ [symbol] ³, which is a mean unit vector of all its viewing directions (the rays that join the point with the optical center of the keyframes that observes it). The set of all the viewing direction of Mⱼ can be denoted by d_{j,k}∈ [symbol] ³:k∈ [symbol] ᵢ}, where [symbol] ⱼ is the set of keyframes that observes the map point Mⱼ;
a representative feature descriptor Dⱼ, that is associated with one feature descriptor whose hamming distance is minimum with respect to all other associated descriptors in the keyframes in which the map point Mⱼ is observed;
the maximum and minimum distance, denoted by dⱼ^{(max)} and dⱼ^{(min)} respectively, at which the point can be observed, based on the scale invariance limits of the features.

Key targets may be target objects that appear to be obstacles to radio wave propagation and can cause attenuation or reflection of a radio wave. Once detected, a key target such as chair 308 of FIG. 3 can be provided with a bounding box 342. A set of target classes of potential key targets and their physical properties (e.g. materials, texture, shape, etc.) may be predefined or pretrained in a machine learning classification model (e.g. ConvNets). For a key target Tᵢ the following information may be stored:
A subordinate class and a unique ID of the key target. Each detected key target is classified to a class (e.g., closet, table, wall) and has a unique ID.
Associated features (features) and map points of the key target. In general, features that fall into the bounding box of a detected key target are associated with the key target, as well as the map points associated to these features. Culling mechanisms can be used to detect redundant or mismatched features and map points associated to a key target. Such culling mechanisms are discussed further below.

Keyframes may be considered image frames (“snapshots”) that summarize visual information of the real world. Each keyframe stores all the features in a frame whether or not the feature is associated with a map point. Each keyframe also stores a camera pose. In some examples “pose” may be considered a combination of a position and an orientation of the camera. For a keyframe Kₙ the following information may be stored:
a camera pose matrix Pₙ^{(i→w)}∈ [symbol] ^{3×4} that transforms points from the world to the camera coordinate system. A camera pose matrix Pₙ^{(i→w)}=[Rₙ^{(c)}|cₙ] comprises a rotation matrix Rₙ^{(c)}∈ [symbol] ^{3×3} describing the camera's orientation with respect to the world coordinate axes, and a column vector cₙ∈ [symbol] ³ describing the location of the camera-center in the world coordinates;
camera intrinsic information including focal length and principal point;
all features extracted in the frame, denoted by set [symbol] (Kₙ), whether the features are associated or not with a map point;
all detected key targets in the frame, denoted by set [symbol] (Kₙ), and their corresponding bounding boxes (such as bounding box 342 of a chair shown in FIG. 3). The bounding boxes may then be used for associating the features extracted in the same frame and furthermore the map points

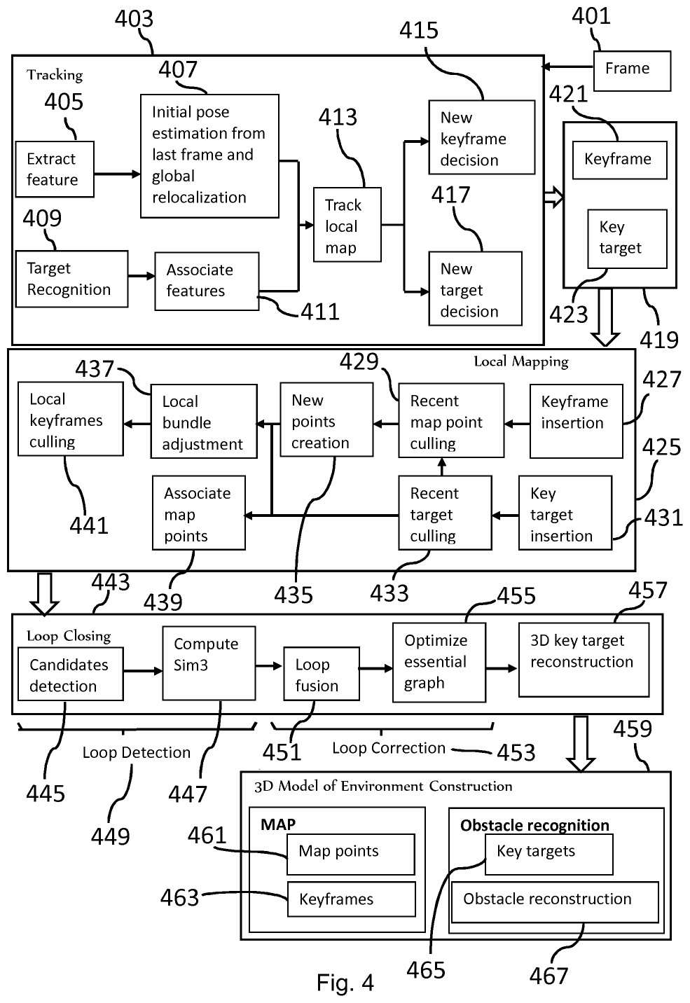

An example of a method for constructing a three dimensional model of an environment is described with reference to FIG. 4.

Prior to carrying out the method of FIG. 4, map initialization may take place. Map initialization computes a relative pose between two frames to triangulate an initial set of map points. This may be done by extracting initial features that correspond to each other in current and reference frames and computing in parallel the homography (planar scenes) and fundamental matrix (nonplanar scenes) with normalized direct linear transformation (DLT) and eight-point algorithms, respectively, for model selection between the algorithms. If planar scenes are detected, homography may be computed using the DLT algorithm. If nonplanar scenes are detected, a fundamental matrix may be computed using eight-point algorithms. A scene is a view from a certain angle of view of an environment. For example, an environment could be a whole room, but a scene could be a corner of the room viewing from a specific angle of view. Once an initial map exists, tracking 403 estimates the camera pose with every incoming frame.

At 401, there is provided incoming image information. The image information may be a frame, and may be a 2D image frame or a 2D video frame. At 405, feature extraction and tracking is performed using feature detection and tracking functions, which may for example be OpenCV feature detection and tracking functions and/or the feature detection and tracking functions described in the above. At 407, initial pose estimation and/or global relocalization is performed. The tracking of features tries to obtain a first estimation of the camera pose from the last frame. For example, with a set of 3D to 2D correspondences the camera pose can be computed a Perspective-n-Point (PnP) problem inside a Random Sample Consensus (RANSAC) scheme. If tracking from an earlier or previous frame is lost, a keyframe database for relocalization candidates may be queried based on similarity between the keyframes in the database and the current keyframe. For each candidate keyframe the feature correspondences and the feature associated to map points in the keyframe are computed. By doing this a set of 2D to 3D correspondence for each candidate keyframe is obtained. RANSAC iterations are performed alternatively with each candidate and camera pose computation is attempted.

At 409, key target detection (target recognition) is performed using object recognition techniques, e.g., ConvNets in a deep learning framework. For training the model a dataset of images containing relevant objects (e.g., obstacles that can affect radio propagation such as large equipment, wall, closet, etc.) may first be collected. The objects may be given training labels. More detailed classification can be achieved by including material or size of the key target in the labels. The trained model is used for real-time key target object detection performed on the selected keyframes. If a service provider collects new images comprising new types of objects, the training model can be updated by introducing more target classes or by customizing target classes.

At 411, features are associated to key targets found at 409. Each detected key target in a keyframe is associated with a bounding box (e.g. 342 shown in FIG. 3). Features within the bounding box are associated to a unique target ID. If a same feature (same feature is tracked in the successive frames based on the descriptor) locates in the bound boxes of different key targets in successive frames, a key target in which the feature appears most frequently is selected.

At 413, local map tracking is performed. A local map is a set of keyframes sharing a similar location with the current frame. While feature tracking helps find a first estimation of the camera pose in an environment, with the estimated camera pose, it is possible to project the map points onto the keyframes of a local map, and associate or reject the map points among the local map keyframes. A map point can be associated to a key target according to its associated feature descriptor and the feature's corresponding target ID. Final pose optimization can be performed using the initial pose estimation and all correspondences found between features in the frame local map points. The camera pose can be optimized by minimizing the reprojection error. For example, a possible approach is to use the Levenberg-Marquadt algorithm with the Huber cost function.

With successful tracking, it can be decided whether to insert a new keyframe (at 415) or a new key target (417). Various criteria can be defined for inserting a new keyframe based on the following parameters: number of frames passed from the last relocalization, number of points tracked by current frame, difference between the number of map points tracked in current frame and in some reference frame (e.g., the frame shares the most map points with the current frame), number of frames passed from the last keyframe insertion or from the finishing of the local bundle adjustment. Criteria for inserting a new key target can also be defined, as in the examples given below.
i. At least N^{(newTar)} points are tracked in a detected bounding box in the current frame.
ii. At least N^{(newPts)} map points included in the detected bounding box are not associated to an existing target id.
iii. At least N^{(passFr)} frames have passed from the last keyframe insertion.

Following tracking at 403, at 419 a new keyframe 421 or key target 423 may be provided as described above. Local mapping 425 may then be performed. During new key target insertion 431 or new keyframe insertion 427, a target database may be updated. A covisibility graph characterizing the similarity between the keyframes may also be updated. A covisibility graph may imply the covisibility information between keyframes. In the covisibility graph, each node may be a keyframe and an edge between two keyframes exists if they share observations of the same map points. A covisibility graph may be created when the first keyframe is input to the system. It may be updated when a new keyframe is inserted.

In some examples, in order to be retained in the map, newly created map points and targets may be required to pass culling tests at 429 and 433. For example, the tracking must find the point (or a minimum number of points associated to a target) in at least a defined percentage of the frames in which the point(s) is(are) predicted to be visible, or/and, if more than one keyframe has passed since map point or target creation, it must be observed from at least N^{(createFr)} frames. These culling tests may be used to reduce redundancy and also to decrease noise in the constructed 3D model of the environment.

At 435, new map points are created by triangulating features in different keyframes. This may be done for example using Parallel Tracking and Mapping (PTAM) to triangulate points with the closest keyframe. This could also be done, for example, using Orientated FAST and Rotated BRIEF (Binary Robust Independent Elementary Features) Simultaneous Localization and Mapping (ORB-SLAM) which uses a few neighbouring keyframes in the covisibility graph that share the most map points. In examples, keypoints may be considered the detected features in each keyframe whose positions (in 2D images) are different from one frame to the other. For example, two keypoints detected in two keyframes may refer to the one same map point in 3D space. Therefore, keyframes sharing more same map points (i.e., a subset of keypoints detected in one keyframe and a subset of keypoints detected in another keyframe are mapped to the same set of map points) may be considered as “close” neighbouring keyframes. If a feature is associated to a detected key target, then its corresponding map point is associated to the same key target at 439.

At 437, local bundle adjustment can take place. Bundle adjustment (BA) may be considered a problem on the 3D structure of the environment and viewing parameters of the environment. The local BA optimizes the currently processed keyframe and all of the keyframes connected to it in the covisibility graph. It also optimizes all of the map points seen by these keyframes. Among the possible approaches, the Levenberg-Marquadt Algorithm can be used.

At 441, local keyframe culling may be performed to reduce redundancy. Criteria can be defined to discard keyframes, for example if more than N^{(overlapPts)} overlapping map points are seen at least in other N^{(cullFr)} keyframes.

At 443, loop closing processes may be performed. Loop closing 443 may comprise loop detection 449 and loop correction 453. Loop detection 449 may comprise loop candidate detection 445 and computing a similarity transformation 447. Loop correction 453 may comprise loop fusion 451 and so-called “essential graph” optimization 455. The loop detection 449 and loop correction 453 steps may comprise similar steps to the loop detection and loop correction steps of the ORB-SLAM algorithm.

At 457, 3D key target reconstruction can be used to construct obstacles (objects) in the map. This may be achieved by using the map points, their corresponding target ids and the target classes to reconstruct the obstacles in the 3D space. An exemplary solution for this is to create a 3D convex hull of each set of the map points belonging to the same target ids, and to use the information included in the target class label (e.g., the materials or reflection surface) to reconstruct the 3D object (the propagation obstacle) in the map. If more information is provided, e.g., the size or shape of the object, the map points belonging to the same target ID with the size or shape can be fitted, and improve the 3D reconstruction of the object.

At 459, a 3D model of the environment of the input frame 401 can be constructed. This may comprise information regarding key targets 465 and map points 461 in the environment. Obstacles (objects) can be reconstructed in the 3D model at 467. Keyframes 463 can also be output from the method schematically shown in FIG. 4.

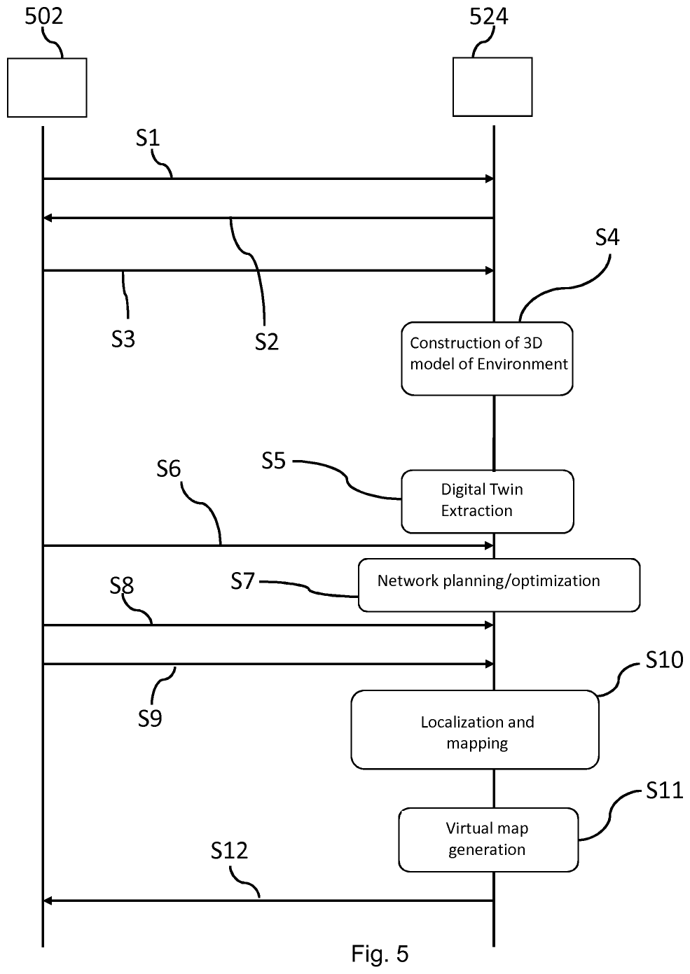

The 3D model of the environment produced by the method schematically shown in FIG. 4 may be used to obtain information to generate a radio propagation model of the environment of a user device. An exemplary method for generating and using a radio propagation model is described herein with reference to FIG. 5.

FIG. 5 shows an exemplary method in which a user device 502 and server 524 are in communication. It is to be appreciated that certain steps of FIG. 5 can be performed in an order other than that shown in FIG. 5, and that some steps of FIG. 5 may be optional in some examples.

The user device and server may be in communication across an interface such as interface 226 shown schematically in FIG. 2.

At S1, the user device 502 sends a request to the server 524 to start a service.

At S2, the server 524 requests access to an image information recording unit, which may be a camera.

Following S2, there may be an optional requirement for a user to give permission for image information such as image/video frames to be sent to the server 524.

At S3, the image information is sent to the server 524. To protect the user's privacy, the image data can be optionally filtered before it is sent. For example, regions in an image detected or determined to be sensitive can be scrambled or pixelated before the image is sent. At S3, other measurements such as movement information, location information and radio signal measurement information may also be sent. This information may be used to calibrate the radio propagation model generated at S5. For example, signal strength and an estimated position in the environment (estimated using a localization and mapping technique) may be used to update the radio propagation model. This information could also be used to update information regarding an AP type.

The server 524 may store information regarding AP types, for example antenna models.

At S4, a 3D model of the environment shown in the image information is constructed as described above. The user device may be located in the environment of which the 3D model is constructed. As described above, this may be achieved by using a localization and mapping technique, such as SLAM, and an object recognition technique, such as ConvNets.

Exemplary possible outputs of the 3D model construction of the environment at S4 comprise: information of a user device's position within the 3D environment; information of a user device trajectory and viewpoint; a 3D map of the environment; information of a position and shape of the main obstacles (objects) in the environment that may reflect or block radio waves and information of the surface material of the main obstacles. These outputs can be used to extract (obtain) information to generate a radio propagation model of the environment (“a digital twin of the environment”) at S5.

At S6, network requirements and/or context information are sent from the user device 502 to the server 524. The network requirements and/or context information may be used by the server device 524 in network planning and/or optimization tasks. The network requirements and/or context information may be used by the server device 524 in constructing a 3D model of the environment or in generating a radio propagation model of the environment. It should be noted that S6 may occur at another point in FIG. 5, for example before or at the same time as S1.

The network requirements and/or context information may comprise information regarding a preferred type of AP. The network requirements and/or context information may comprise information regarding a user's preferred AP deployment location (this information may comprise at least one deployment location for at least one AP). The network requirements and/or context information may be provided to the user device via haptic and/or speech feedback from a user at the user device 502. The network requirements and/or context information may be recorded by sensors at the user device 502. The network requirements and/or context information may be provided over a user interface at the user device 502. The network requirements and/or context information may comprise information regarding coverage areas provided by a user at the user device, for example areas of low latency or high network reliability marked by a user using a user interface of the user device 502. The network requirements and/or context information may comprise information regarding an installed type of AP. The network requirements and/or context information may also comprise information regarding locations of APs. The network requirements and/or context information may comprise information regarding quality of service requirements.

At S7, network planning and/or optimization can be performed. For network planning functions, an AP may not yet be deployed in the environment, and the network planning can be performed to determine the optimal location for the AP to be deployed. For network optimization functions, at least one AP may already be deployed in an environment.

Ray tracing may be used to generate radio propagation channels and to generate virtual radio maps using the radio propagation model. Ray tracing is a method of calculating the path of waves or particles through a system with regions of varying propagation velocity, absorption characteristics, and reflecting surfaces.

For network planning, the server 524 may use information regarding a preferred type of AP or installed AP sent from the user device at S6. The server 524 may also use the AP preferred type and/or AP installed type and the radio propagation model to generate a virtual radio coverage map. The server 524 may additionally use a location of the AP in the environment to generate the virtual radio coverage map.

For network optimization, the object recognition technique used at S4 may determine information of a type of AP deployed in an environment. The object recognition may also determine information of a location of an AP in the environment. The server may use this information in the network optimization. The server may also use the AP type and/or location information and the radio propagation model to generate a virtual radio coverage map.

The network planning and optimization functions of the server 524 can provide a suggested optimal deployment location of an AP. The server 524 may suggest to deploy multiple APs, and may suggest multiple optimal deployment locations of multiple APs. Multiple AP deployment may be suggested for large areas. It can also give suggestions of optimized configuration parameters of the user device 502 or the AP. The generated virtual radio map can be used for coverage and capacity optimization in a self-organizing wireless network.

At S8, the user device 502 sends a visualization request to the server 524. The visualization request could be for visualizing a virtual radio coverage map, or for visualizing an optimized deployment location for an AP.

At S9, the user device 502 sends image information and other measurement information as in S3. At S10, a localization and mapping technique can be used to determine a user device's position and viewpoint. A user device's trajectory may also be determined using a localization and mapping technique. At S11, a virtual radio coverage map may be generated. This may comprise a gridded radio map of the 3D space. At S12, the suggested optimal deployment location can be sent overlaid on image information captured by the user device. This image information may be real-time images frames. The optimal deployment location can then be viewed on the display of the user device 502. Other information may be sent at S12, such as performance metrics to be displayed at user device 502. This information may be sent instead of an optimal deployment location or as well as an optimal deployment location. These performance metrics may comprise network capacity information (for example network capacity information in terms of data rate) or network latency information.

The virtual radio coverage map produced using this method may be useful in that a user can specify any arbitrary point in the 3D environment and can then be given radio coverage information for that point. This means that a user can specify any coordinate of length, width and height in a 3D environment and be provided with a measurement for that coordinate. This provides a quick and efficient position-dependent network performance estimation in 3D space.

In an example, a user can visualize the 3D radio coverage map by specifying a height value using the user device. A 2D virtual radio map in that plane and for that height could then be provided to the user. The user could similarly limit any other dimension in the 3D space to be provided with a 2D virtual radio map. The map could be colour coded to show differences in radio coverage (e.g. green representing good coverage, red representing poor coverage). The map could also be rendered in 3D, with peaks at certain 2D points corresponding to areas of better radio coverage and troughs corresponding to areas or poorer radio coverage. The map can be shown on the display of the user device 502.

A user can visualize the radio map by being provided with a projection of the map onto surfaces (such as walls, ceilings or the surfaces of objects). This could be shown on the display of the user device 502.

In some examples, multiple APs may be used in an environment.

In some examples, multiple AP deployment locations can be suggested such that a user can select their preferred location to be use. This may be useful where a user has area-specific concerns, which may be related to security or safety for example.

The method and apparatus described herein may be used in 5G fixed wireless access (FWA) outdoor scenarios. FWA is used for providing wireless broadband services (e.g. mmWave access with narrow beamwidth) to home and small-to-medium enterprise where there is no (or limited) infrastructure with space for wired broadband. In FWA, two fixed locations are often required to be connected directly with fixed APs deployed. As well as connecting one-to-one locations, FWA can also be implemented in point-to-multipoint and multipoint-to-multipoint transmission modes. The method and apparatus described herein can be used to decide where to deploy the fixed wireless APs in the 3D space (e.g., mounted on towers or buildings, roof-mounted or wall-mounted, and at which position exactly) to maximize the capacity of the direct (line of sight) wireless communication links.

An unmanned aerial vehicle (UAV) could be used to collect the video/image data, GPS information, and the corresponding received signal strength or other network performance measurements. This may be useful in a FWA scenario. Using the 3D model construction method described herein, and the network planning/optimization methods based on the extracted “digital twin” described herein, optimized locations to deploy the fixed wireless accesses can be shown to a user, and the virtual network performance in the 3D space for an outdoor scenario via a mobile user interface assisted with augment reality, i.e., the optimized deployment location and the virtual network performance can be overlaid on the real-world images (or video streams) on a user device interface.

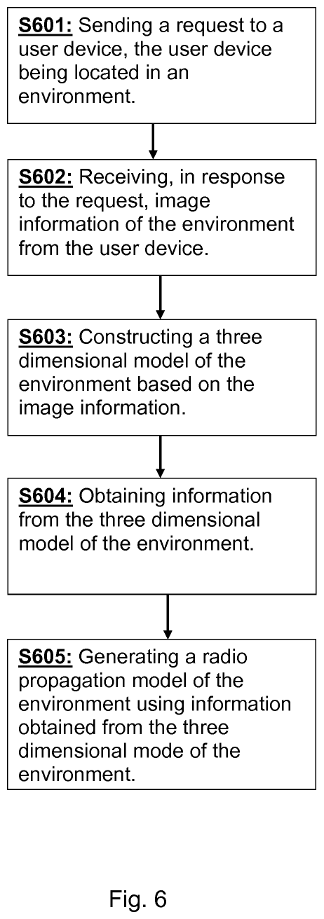

FIG. 6 shows an example method. The method may be performed by a server. The method comprises sending a request to a user device, the user device being located in an environment at S601. At S602, the method comprises receiving, in response to the request, image information of the environment from the user device. At S603, the method comprises constructing a three dimensional model of the environment based on the image information. At S604 the method comprises obtaining information from the three dimensional model of the environment. At S605 the method comprises generating a radio propagation model of the environment using information obtained from the three dimensional mode of the environment.

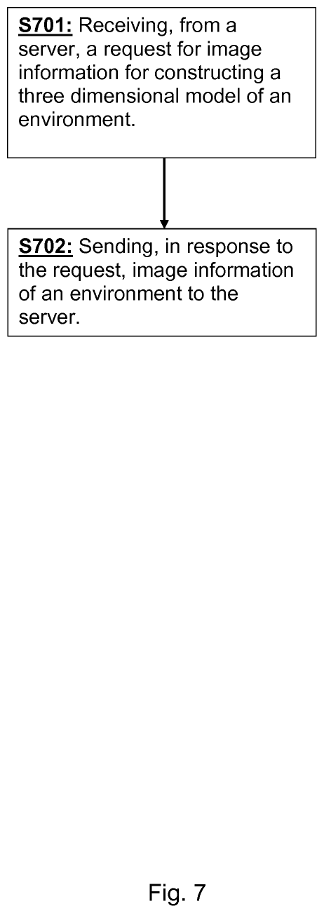

FIG. 7 shows an example method. The method may be performed by a user device. The method comprises receiving from a server, a request for image information for constructing a three dimensional model of an environment at S701. At S702, The method further comprises sending, in response to the request, image information of an environment to the server.

In general, the various examples shown may be implemented in hardware or in special purpose circuits, software, logic or any combination thereof. Some aspects may be implemented in hardware, while other aspects may be implemented in firmware or software which may be executed by a controller, microprocessor or other computing device, although the invention is not limited thereto. While various aspects may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Some embodiments may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out methods are described in the present disclosure. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Examples of the disclosed embodiments may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1.-38. (canceled)

39. An apparatus, comprising:
at least one processor; and
at least one memory containing computer program code;
the at least one memory and computer program code configured, with the at least one processor, to cause the apparatus to perform:
sending a request to a user device, wherein the user device is located in an environment;
receiving, in response to the request, image information of the environment from the user device;
constructing a three dimensional model of the environment based on the image information;
obtaining information from the three dimensional model of the environment; and
generating a radio propagation model of the environment using information obtained from the three dimensional model of the environment.

40. The apparatus according to claim 39, wherein the constructing a three dimensional model of the environment comprises:
using a localization and mapping technique and an object recognition technique;
detecting an object in the environment using the object recognition technique; and
constructing a position and shape of the object in the three dimensional model of the environment, wherein the constructing a three dimensional model comprises determining a material or type of the object using the object recognition technique.

41. The apparatus according to claim 39, wherein the obtaining information comprises obtaining at least one of: information of a user device's position within the three dimensional environment; information of a position and shape of at least one object in the three dimensional environment; information of a surface material of at least one object in the environment.

42. The apparatus according to claim 40, wherein the constructing a three dimensional model comprises determining a position of an access point located in the environment using the object recognition technique.

43. The apparatus according to claim 42, wherein the constructing a three dimensional model comprises recognising a type of the access point located in the environment.

44. The apparatus according to claim 42, wherein the at least one memory and computer program code are further configured, with the at least one processor, to cause the apparatus to perform: generating a virtual radio coverage map or at least one performance metric based on: the radio propagation model; the determined position of the access point located in the environment and the recognized type of the access point.

45. The apparatus according to claim 39, wherein the at least one memory and computer program code are further configured, with the at least one processor, to cause the apparatus to perform: receiving, from the user device, information regarding a preferred type of access point of the user device or receiving information regarding a preferred access point deployment location of the user device.

46. The apparatus according to claim 45, wherein the at least one memory and computer program code are further configured, with the at least one processor, to cause the apparatus to perform: generating a virtual radio coverage map or at least one performance metric based on: the radio propagation model; a position of the access point in the environment and the preferred type of access point.

47. The apparatus according to claim 46, wherein the at least one memory and computer program code are further configured, with the at least one processor, to cause the apparatus to perform: providing a suggested optimized access point deployment location to the user device.

48. A method, comprising:
sending a request to a user device, wherein the user device is located in an environment;
receiving, in response to the request, image information of the environment from the user device;
constructing a three dimensional model of the environment based on the image information;
obtaining information from the three dimensional model of the environment; and
generating a radio propagation model of the environment using information obtained from the three dimensional model of the environment.

49. The method according to claim 48, wherein the constructing a three dimensional model of the environment comprises using a localization and mapping technique and an object recognition technique.

50. The method according to claim 48, wherein the constructing a three dimensional model comprises detecting an object in the environment using the object recognition technique and constructing a position and shape of the object in the three dimensional model of the environment.

51. The method according to claim 48, wherein the constructing a three dimensional model comprises determining a material or type of the object using the object recognition technique.

52. The method according to claim 48, wherein the obtaining information comprises obtaining at least one of: information of a user device's position within the three dimensional environment; information of a position and shape of at least one object in the three dimensional environment; information of a surface material of at least one object in the environment.

53. The method according to claim 48, wherein the constructing a three dimensional model comprises determining a position of an access point located in the environment using the object recognition technique.

54. The method according to claim 53, wherein the constructing a three dimensional model comprises recognising a type of the access point located in the environment.

55. The method according to claim 53, further comprising: generating a virtual radio coverage map or at least one performance metric based on: the radio propagation model; the determined position of the access point located in the environment and the recognised type of the access point.

56. The method according to claim 48, further comprising: receiving, from the user device, information regarding a preferred type of access point of the user device or receiving information regarding a preferred access point deployment location of the user device.

57. The method according to claim 56, further comprising: generating a virtual radio coverage map or at least one performance metric based on: the radio propagation model; a position of the access point in the environment and the preferred type of access point.

58. A method, comprising:
receiving, from a server, a request for image information for constructing a three dimensional model of an environment in which the apparatus is located; and
sending, in response to the request, image information of an environment to the server.
